(19) United States
(12) Patent Application Publication
(10) Pub. No.: US 2017/0346656 A1
(43) Pub. Date: Nov. 30, 2017

(54) SYSTEM AND METHOD FOR DATA GENERATOR DRIVEN BUS CLOCK VOTING

(71) Applicant: QUALCOMM INCORPORATED, SAN DIEGO, CA (US)

(72) Inventors: AJAY NAWANDHAR, BANGALORE (IN); PAVAN KUMAR, BANGALORE (IN); KIRAN KUMAR MALIPEDDI, SECUNDERABAD (IN); CHANDRASEKHAR REDDY RAMREDDY GARI, HYDERABAD (IN)

(21) Appl. No.: 15/168,066

(22) Filed: May 29, 2016

(51) Int. Cl. H04L 12/40; H04L 7/04

(52) U.S. Cl. CPC H04L 12/4013; H04L 7/04

(57) ABSTRACT

Various embodiments of methods and systems for data generator driven bus clock voting are disclosed. An exemplary embodiment defines a first timing domain within a system on a chip to comprise a data generating component and a bus that includes a memory management unit. The bus serves to communicatively couple the data generating component to a memory component, such as a DDR. A second timing domain within the system on a chip comprises the memory component. With such a configuration, the embodiment may leverage the clock speed of the data generating component to set a clock speed for components in the first timing domain and, in doing so, the clock speed of the memory management unit is dictated by the first timing domain.

### DESCRIPTION OF THE RELATED ART

Portable computing devices (“PCDs”) commonly contain integrated circuits, or systems on a chip (“SoC”), that include numerous components designed to work together to deliver functionality to a user. For example, a SoC may contain any number of master components such as modems, displays, central processing units (“CPUs”), graphical processing units (“GPUs”), etc. that are used by application clients to process workloads. In processing the workloads, the master components read and/or write data and/or instructions to and/or from memory components on the SoC. The data and instructions may be generally termed “transactions” and are transmitted between the devices via a collection of wires known as a bus.

Put simply, a data generator, such as a GPU, transmits data and instructions over a bus to a memory component, such as a double data rate (“DDR”) memory. As would be understood by one of ordinary skill in the art, the data generator is supplied power at varying clock frequencies depending on its workload. If the data generator workload is low, then the power frequency supplied to it may also be relatively low in order to avoid unnecessary power consumption. Conversely, if the data generator workload is high, then the power frequency supplied to it may also be relatively high so that the data generator can quickly and efficiently process its workload. Similarly, the memory component is supplied power at varying clock frequencies depending on its demand level. The bus and its memory management unit (translation lookaside buffer), which accommodates the transaction stream between the data generator and the memory component, is typically powered at a frequency dictated by the memory component. That is, the memory management unit and memory component are in the same time domain such that the bus clock frequency is matched to the memory component clock frequency.

Notably, when the data generator clock frequency is relatively high (such as when the data generator is in a “turbo” mode) while the bus/memory clock frequency is relatively low, the system may experience a “bubble” in the performance as a transaction queue emanating from the data generator builds up to the detriment of average transaction latency. Further, when the data generator clock frequency is relatively low (such as when the data generator is in a “sleep” or “standby” or “low power” mode) while the bus/memory clock frequency is relatively high, the memory management unit may be unnecessarily consuming power as the transaction queue emanating from the data generator is of a minimal bandwidth requirement.

Therefore there is a need in the art for a system and method that optimizes bus bandwidth availability when demand is high from a data generator and minimizes memory management unit power consumption when demand is low from a data generator. More specifically, what is needed in the art is a system and method that votes a bus clock based on the demand driven by a data generator.

### SUMMARY OF THE DISCLOSURE

Various embodiments of methods and systems for data generator driven bus clock voting are disclosed. An exemplary embodiment defines a first timing domain within a system on a chip to comprise a data generating component and a bus that includes a memory management unit. The bus serves to communicatively couple the data generating component to a memory component, such as a DDR. A second timing domain within the system on a chip comprises the memory component. With such a configuration, the embodiment may leverage the clock speed of the data generating component to set a clock speed for components in the first timing domain and, in doing so, the clock speed of the memory management unit is dictated by the first timing domain. A dynamic current and voltage scaling module, or dynamic voltage and frequency scaling module, may react to triggers to adjust the clock speeds of the data generating component and the memory component, thereby also adjusting the clock speed settings of the respective timing domains. In this way, because the bus and memory management unit are associated with the first timing domain, as the power frequency supplied to the data generating component changes, so does the power frequency of the memory management unit without reference to the power frequency supplied to the memory component.

Advantageously, when the data generating component is running at a high clock speed and the memory component is not, the memory management unit may be leveraged to mitigate impact on transaction latencies by accommodating a portion of transaction requests emanating from the data generating component. Conversely, when the data generating component is running at a relatively slow clock speed and the memory component is not, the memory management unit may avoid unnecessary power consumption because the transaction request levels emanating from the data generating unit are low.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an exemplary, non-limiting aspect of a portable computing device (“PCD”) in the form of a wireless telephone for implementing data generator driven bus clock voting (“BCV”) systems and methods;

FIG. 2 is a functional block diagram illustrating an exemplary embodiment of an on-chip system for data generator driven bus clock voting (“BCV”); and

FIG. 3 is a logical flowchart illustrating an exemplary method for data generator driven bus clock voting (“BCV”) according to the solution.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference to double data rate “DDR” memory components will be understood to envision any of a broader class of volatile random access memory (“RAM”) used for long term data storage and will not limit the scope of the solutions disclosed herein to configurations or arrangements that include a specific type or generation of RAM.

As used in this description, the terms “component,” “database,” “module,” “system,” “generator,” “engine,” “controller,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”

In this description, the terms “engine,” “processing engine,” “master processing engine,” “master component,” “data generator” and the like are used to refer to any component within a system on a chip (“SoC”) that generates transaction requests to closely coupled memory devices and/or to components of a memory subsystem via a bus. As such, a master component may refer to, but is not limited to refer to, a CPU, DSP, GPU, modem, controller, display, camera, etc. A master component comprised within an embodiment of the solution, depending on its particular function and needs, may dictate the clock frequency for a master component time domain that includes a bus.

In this description, the terms “memory management unit,” “MMU,” “translation lookaside buffer,” and “TLB” are used interchangeably to refer to a component associated with a bus and having all transaction requests from a data generator passed through it for the purpose of performing translations of virtual memory addresses in a cache to physical memory addresses in the DDR.

In this description, the terms “bus,” “bus interconnect,” “advanced extensible interface (“AXI”)” and the like are used interchangeably and refer to a collection of wires through which data is transmitted from a data generator to a memory component or other device located on or off the SoC. It will be understood that a bus consists of two parts—an address bus and a data bus where the data bus transfers actual data and the address bus transfers information specifying location of the data in a memory component. The term “width” or “bus width” or “bandwidth” refers to an amount of data, i.e. a “chunk size,” that may be transmitted per cycle through a given bus. For example, a 16-byte bus may transmit 16 bytes of data at a time, whereas 32-byte bus may transmit 32 bytes of data per cycle. Moreover, “bus speed” refers to the number of times a chunk of data may be transmitted through a given bus each second. Similarly, a “bus cycle” or “cycle” refers to transmission of one chunk of data through a given bus. The bus speed for a given bus may be driven or dictated by the clock frequency of a data generator associated with the bus in embodiments of the solution.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In current systems and methods, a bus interconnect's dynamic clock and voltage scaling (“DCVS”) power scheme may be determined by a memory controller or, by extension, a memory device managed by the memory controller. As such, the bus may run at a relatively slower clock frequency when a data generator associated with the bus is running at a relatively higher DCVS rate and generating a high volume of transaction requests. Notably, when a data generator is generating a high volume of transaction requests while its associated bus is running at a relatively lower bus speed, a bubble in the performance of the overall system-on-chip (“SoC”) may occur.

As an example of the loading scheme mentioned above, in the prior art when a GPU workload is low (thereby dictating a Supply Voltage Supervisor (“SVS”) or a nominal (“NOM”) mode), while the memory load is high (thereby dictating a “Turbo mode” for the memory), the bus interconnect between them may be running at a high clock speed causing it to consume extra power. Conversely, in the prior art when a GPU workload is high (“Turbo mode”), while the memory load is low (thereby dictating a Supply Voltage Supervisor (“SVS”) or a nominal (“NOM”) mode), the bus interconnect between them may be running at a low clock speed that negatively impacts system performance.

To mitigate or alleviate the shortcomings of the prior art arrangements, embodiments of the solution provide for a DCVS voting scheme for a bus interconnect that is driven by a data generator master component. To do this, embodiments recognize when a given data generator, like a GPU, has a low workload and is running a FIFO on a low clock speed. In such a scenario, an embodiment of the solution may run the bus interconnect clock at a frequency consistent with that of the GPU knowing that back pressure in the system may be minimal because the GPU is sending relatively fewer transaction requests to the DDR memory device. Advantageously, power consumption from the bus interconnect may be minimized when transaction bandwidth is on low demand from the GPU.

When the GPU experiences a high workload and the FIFO is on a high clock speed, embodiments of the solution may be configured to respond to the bandwidth demands with the bus interconnect already being driven at a clock speed dictated by that of the GPU, thereby optimizing overall performance of the PCD.

A further advantage of embodiments of the solution is that, given most of the data typically requested by a master component is already cached in a memory management unit (“MMU”) running on the AXI clock, the transaction requests of the master component may be satisfied from the MMU, thereby avoiding buildup of a transaction request queue, even when the master component and the bus memory interconnect are running at a relatively higher speed than the DDR memory device.

Thus, the novel DCVS voting scheme encompassed by embodiments of the solution may be determined by a core of a multi-core processor in order to match the core's faster/slower bandwidth requirements. In this way, when a core needs faster data, the memory interconnect may run faster and when the core generates slower requests, the bus interconnect may also be slowed commensurately. Moreover, given that most data of a PCD is cached in the MMU (which runs on a bus clock), in embodiments of the solution much of the data typically requested may be returned to the master component quickly even if the memory component speed is slower (e.g., GPU in turbo mode while DDR is in SVS mode).

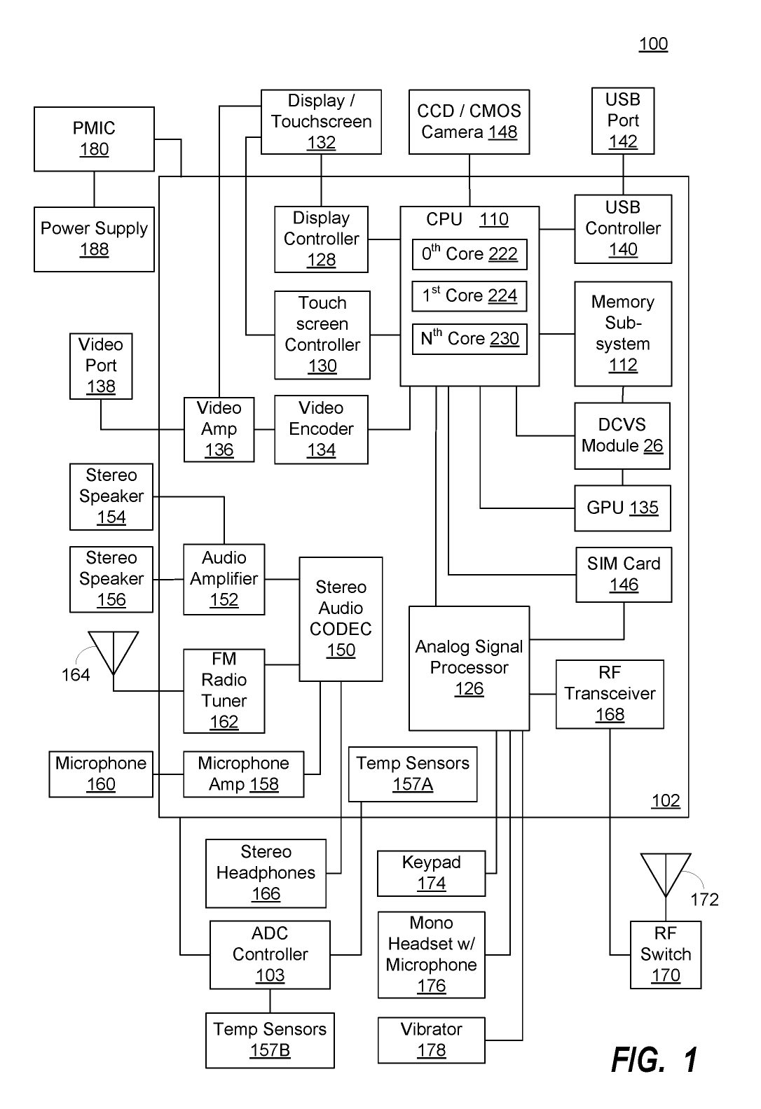

FIG. 1 is a functional block diagram illustrating an exemplary, non-limiting aspect of a portable computing device (“PCD”) in the form of a wireless telephone for implementing data generator driven bus clock voting (“BCV”) systems and methods. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art. Any of the processing units, including but not limited to, the CPU 110 (or any of its cores individually), GPU 135, etc. may be a master component that dictates a clock speed domain associated with the bus.

In general, the memory subsystem 112 comprises, inter alia, a memory controller 215, dedicated caches and FIFOs for master components, MMU/TLB 116, and a DDR memory 115 (collectively depicted in the FIG. 1 illustration as memory subsystem 112). The memory subsystem 112 in general, and some of its components specifically, may be formed from hardware and/or firmware. Advantageously, by leveraging the presence of requested data in the MMU, BCV solutions mitigate system backpressure on a transaction queue even when the requesting component and the bus 205 (not shown in FIG. 1) are running at a higher clock speed than the long term memory device (such as DDR 115).

As illustrated in FIG. 1, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136.

As depicted in FIG. 1, a universal serial bus (“USB”) controller 140 is coupled to the CPU 110. Also, a USB port 142 is coupled to the USB controller 140. The memory subsystem 112, which may include a PoP and/or non-PoP memory, a mask ROM/Boot ROM, a boot OTP memory, an MMU 116 (see subsequent Figures), a DDR memory 115 (see subsequent Figures), and caches may also be coupled to the CPU 110 and/or include its own dedicated processor(s). A subscriber identity module (“SIM”) card 146 may also be coupled to the CPU 110. Further, as shown in FIG. 1, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 126. An RF switch 170 may be coupled to the RF transceiver 168 and an RF antenna 172. As shown in FIG. 1, a keypad 174 may be coupled to the analog signal processor 126. Also, a mono headset with a microphone 176 may be coupled to the analog signal processor 126. Further, a vibrator device 178 may be coupled to the analog signal processor 126. FIG. 1 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 1 may reside on chip 102 in other exemplary embodiments.

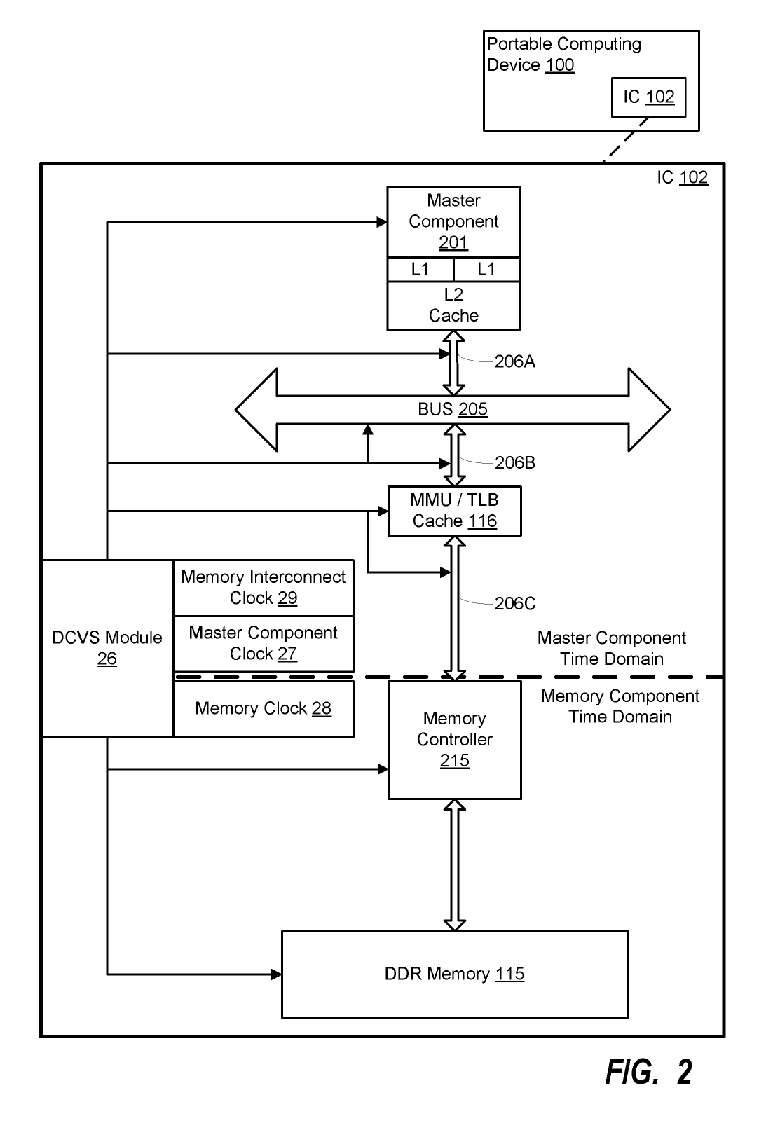

In a particular aspect, one or more of the method steps described herein may be implemented by executable instructions and parameters stored in the memory subsystem 112 or as form the DCVS module 26 and/or the clocks 27, 28 (see FIG. 2). Further, the memory subsystem 112, the DCVS module 26 and/or the clocks 27, 28, the instructions stored therein, or a combination thereof may serve as a means for performing one or more of the method steps described herein.

FIG. 2 is a functional block diagram illustrating an exemplary embodiment of an on-chip system for data generator driven bus clock voting (“BCV”). In the FIG. 2 illustration, the master component 201 may be processing a workload according to the demands of various application clients and, in doing so, may be issuing read and write transactions to the DDR 115 via bus 205 and memory interconnects 206. The extent of the workload and/or the priority of the workload may dictate the “power mode” or power frequency at which the master component 201 running, as would be understood by one of ordinary skill in the art. The DCVS module 26, taking cues from any number of possible triggers, such as but not limited to workload scheduling queues, thermal energy generation measurements, user settings, etc., may work with the master component clock 27 to provide power to the master component 201 at an optimum frequency. Similarly, the DCVS module 26, taking cues from any number of possible triggers, may work with the memory clock 28 to provide power to the memory 115 and memory controller 215 at an optimum frequency to meet its particular requirements for functionality. Notably, the DCVS module 26, may work with the memory interconnect clock 29, which has an optimum speed setting dictated by the clock speed setting of the master component clock 27 (i.e., the memory interconnect clock 29 is a “slave” to the “master” master component clock).

The transactions emanating from the master component 201 are marshaled by memory controller 215. However, when the master component 201 clock speed exceeds the DDR 115 clock speed, embodiments of a BCV solution may leverage data stored in the MMU 116 to satisfy the transaction requests, thereby avoiding a backlog of the transaction queue. Advantageously, because embodiments of a BCV solution set the memory interconnect clock 29 at the speed dictated by the master component time domain (which is dictated by the memory component clock 27), instead of the clock speed associated with the memory component time domain, requests that can be satisfied from the MMU 116 are filled at a fast rate even when the DDR 115 is subject to a low power mode. Additionally, when the memory component time domain is set by the DCVS module 26 (per the memory clock 28) to a high performance mode, such as a turbo mode, and the master component time domain is set by the DCVS module 26 (per the master component clock 27) to a low performance mode, such as a SVS or NOM mode, embodiments of the solution enable the bus interconnect 206 to avoid unnecessary power consumption when the master component requires low bandwidth because both the master component 201 and the bus interconnect 206 are associated with the same time domain (i.e., the master component 201 and the bus interconnect 206 run at the same frequency associated with the low power mode).

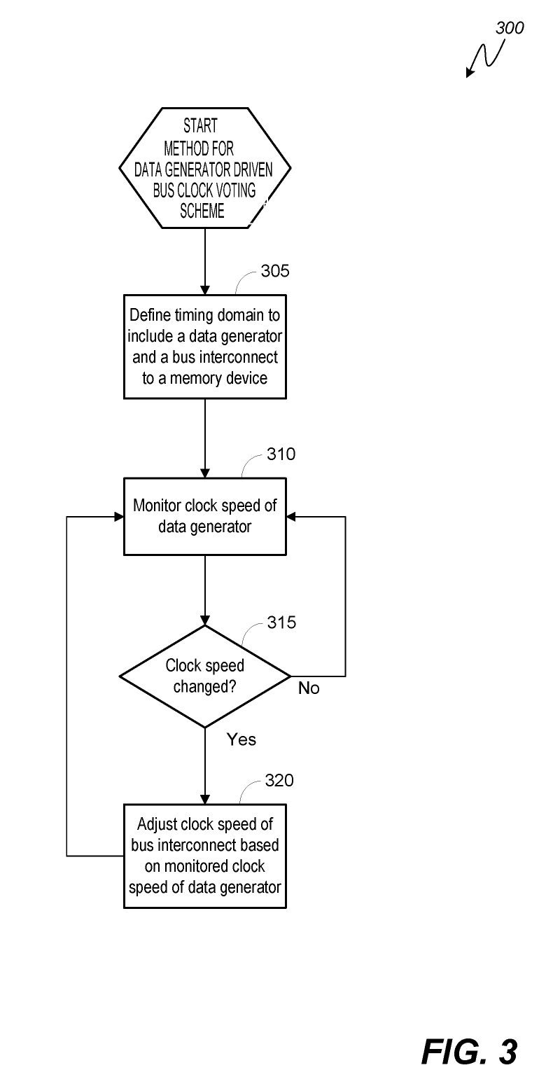

FIG. 3 is a logical flowchart illustrating an exemplary method 300 for data generator driven bus clock voting (“BCV”) according to the solution. Beginning at block 305, a timing domain may be defined to include a master component data generator and a memory interconnect. The bus interconnect may define a transaction request highway between the data generator and a memory component. By defining the timing domain to include the master component and the memory interconnect, but not the memory device, embodiments of the solution may provide for the memory interconnect clock to be driven or voted by the clock frequency most optimal at any given time for the master processing component.

Next, at block 310, the clock speed of the data generator may be monitored and governed by a DCVS module 26 according to the setting of the master component clock 27. The memory interconnect 206 clock 29 may be set to the same speed as the data generator 201 because both components are associated with the same timing domain defined at block 305. At decision block 315, if the clock speed of the data generator changes (per the instructions of the DCVS module 26 working with the master component clock 27), the “yes” branch is followed to block 320 and the clock speed of the memory interconnect 206 is also adjusted to match that of the adjusted data generator clock. The method 300 loops back to block 310 and monitoring continues. If the clock speed of the data generator remains at a given set point unchanged, the “no” branch is followed from decision block 315 back to block 310 and monitoring continues. In this way, embodiments of the solution seek to set the memory interconnect clock speed in view of the associated data generator clock speed. When the DCVS module 26 adjusts the clock speed of the data generator, the clock speed of the memory interconnect is also adjusted to match. As such, when the processing speed of the data generator is high, the memory interconnect clock speed is also high to provide needed bandwidth even though a clock speed of memory component time domain may be relatively slower.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices or software instruction and data structures is not considered necessary for an adequate understanding of how to make and use the invention. The inventive functionality of the claimed computer implemented processes is explained in more detail in the above description and in conjunction with the drawings, which may illustrate various process flows.

In one or more exemplary embodiments, the functions described may be implemented in hardware, software, firmware, or any combination thereof. If implemented in software, the functions may be stored on or transmitted as one or more instructions or code on a computer-readable device. Computer-readable devices include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for data generator driven bus clock voting, the method comprising:
defining a first timing domain within a system on a chip to comprise a data generating component and a bus, wherein the bus comprises a memory management unit and is communicatively coupled to the data generating component and a memory component; and
defining a second timing domain within the system on a chip to comprise the memory component;
wherein a clock speed of the data generating component determines a clock speed setting for the first timing domain and a clock speed of the memory management unit is dictated by the first timing domain.

2. The method of claim 1, further comprising:
monitoring the clock speed of the data generating component;
recognizing a change in the clock speed of the data generating component; and
adjusting the clock speed of the memory management unit based on the recognized change.

3. The method of claim 2, wherein the recognized change in the clock speed of the data generating component is the result of a thermal energy generation trigger.

4. The method of claim 2, wherein the recognized change in the clock speed of the data generating component is the result of a workload scheduling queue trigger.

5. The method of claim 2, wherein the recognized change in the clock speed of the data generating component is the result of a user setting trigger.

6. The method of claim 1, wherein the data generating component is one of a graphics processing unit, a digital signal processor and a central processing unit.

7. A system for data generator driven bus clock voting, the system comprising:
means for defining a first timing domain within a system on a chip to comprise a data generating component and a bus, wherein the bus comprises a memory management unit and is communicatively coupled to the data generating component and a memory component; and
means for defining a second timing domain within the system on a chip to comprise the memory component;
wherein a clock speed of the data generating component determines a clock speed setting for the first timing domain and a clock speed of the memory management unit is dictated by the first timing domain.

8. The system of claim 7, further comprising:
means for monitoring the clock speed of the data generating component;
means for recognizing a change in the clock speed of the data generating component; and
means for adjusting the clock speed of the memory management unit based on the recognized change.

9. The system of claim 8, wherein the recognized change in the clock speed of the data generating component is the result of a thermal energy generation trigger.

10. The system of claim 8, wherein the recognized change in the clock speed of the data generating component is the result of a workload scheduling queue trigger.

11. The system of claim 8, wherein the recognized change in the clock speed of the data generating component is the result of a user setting trigger.

12. The system of claim 7, wherein the data generating component is one of a graphics processing unit, a digital signal processor and a central processing unit.

13. The system of claim 7, wherein the system on a chip is comprised within a portable computing device.

14. A system for data generator driven bus clock voting, the system comprising:
a dynamic current and voltage module operable to:
define a first timing domain within a system on a chip to comprise a data generating component and a bus, wherein the bus comprises a memory management unit and is communicatively coupled to the data generating component and a memory component; and
define a second timing domain within the system on a chip to comprise the memory component;
wherein a clock speed of the data generating component determines a clock speed setting for the first timing domain and a clock speed of the memory management unit is dictated by the first timing domain.

15. The system of claim 14, wherein the dynamic current and voltage module is further operable to:
monitor the clock speed of the data generating component;
recognize a change in the clock speed of the data generating component; and
adjust the clock speed of the memory management unit based on the recognized change.

16. The system of claim 15, wherein the recognized change in the clock speed of the data generating component is the result of a thermal energy generation trigger.

17. The system of claim 15, wherein the recognized change in the clock speed of the data generating component is the result of a workload scheduling queue trigger.

18. The system of claim 15, wherein the recognized change in the clock speed of the data generating component is the result of a user setting trigger.

19. The system of claim 14, wherein the data generating component is one of a graphics processing unit, a digital signal processor and a central processing unit.

20. The system of claim 14, wherein the system on a chip is comprised within a portable computing device.
